(19) United States
(12) Patent Application Publication
(10) Pub. No.: US 2016/0226202 A1
(43) Pub. Date: Aug. 4, 2016

(54) RIGHT ANGLE COAXIAL CABLE AND CONNECTOR ASSEMBLY

(71) Applicant: CommScope Technologies LLC, Hickory, NC (US)

(72) Inventors: Jeffrey D. Paynter, Momence, IL (US); David Smentek, Lockport, IL (US)

(21) Appl. No.: 15/008,095

(22) Filed: Jan. 27, 2016

Related U.S. Application Data
(60) Provisional application No. 62/111,300, filed on Feb. 3, 2015.

(51) Int. Cl. H01R 24/38

(52) U.S. Cl. CPC H01R 24/38

(57) ABSTRACT

A coaxial cable-connector assembly includes a coaxial cable and a right angle coaxial connector. The cable comprises: an inner conductor having a termination end; a first dielectric layer; and an outer conductor having a termination end. The connector comprises: an inner contact comprising a post configured to mate with the inner conductor body of a mating cable jack, the inner contact further including a receptacle that receives the termination end of the inner conductor such that the post is generally perpendicular to the inner conductor; and an outer conductor body configured to mate with the outer conductor body of the mating jack, the outer conductor body being connected with the termination end of the outer conductor. A second dielectric layer is interposed between the inner contact of the connector and the inner conductor of the coaxial cable that creates a capacitive element between the inner contact and the inner conductor.

The present application claims the benefit of and priority from U.S. Provisional Application No. 62/111,300, filed Feb. 3, 2015, the disclosure of which is hereby incorporated herein in its entirety.

### FIELD OF THE INVENTION

The present invention is directed generally to electrical cable connectors, and more particularly to coaxial connectors for electrical cable.

### BACKGROUND OF THE INVENTION

Coaxial cables are commonly utilized in RF communications systems. A typical coaxial cable includes an inner conductor, an outer conductor, a dielectric layer that separates the inner and outer conductors, and a jacket that covers the outer conductor. Coaxial cable connectors may be applied to terminate coaxial cables, for example, in communication systems requiring a high level of precision and reliability.

Coaxial connector interfaces provide a connect/disconnect functionality between (a) a cable terminated with a connector bearing the desired connector interface and (b) a corresponding connector with a mating connector interface mounted on an apparatus or on another cable. Typically, one connector will include an inner contact, such as a pin or post connected to an inner conductor and an outer conductor connector body connected to the outer conductor; these are mated with a mating sleeve (for the pin or post of the inner conductor) and another outer conductor connector body of a second connector. Coaxial connector interfaces often utilize a threaded coupling nut or other retainer that draws the connector interface pair into secure electro-mechanical engagement when the coupling nut (which is captured by one of the connectors) is threaded onto the other connector.

Although many coaxial connectors are configured to be oriented “in line” with their attached cables (i.e., such that the inner contact is generally coaxial with the inner conductor of the cable), some coaxial connectors are configured such that the inner contact is oriented generally perpendicular to the attached cable. These so-called “right angle” connectors can raise different issues than inline connectors when being attached to a cable due to their geometry.

Passive Intermodulation Distortion (PIM) is a form of electrical interference/signal transmission degradation that may occur with less than symmetrical interconnections and/or as electro-mechanical interconnections shift or degrade over time. Interconnections may shift due to mechanical stress, vibration, thermal cycling, and/or material degradation. PIM can be an important interconnection quality characteristic, as PIM generated by a single low quality interconnection may degrade the electrical performance of an entire RF system. Thus, the reduction of PIM via connector design is typically desirable.

### SUMMARY

As a first aspect, embodiments of the invention are directed to a coaxial cable-connector assembly. The assembly comprises a coaxial cable and a right angle coaxial connector. The coaxial cable comprises: an inner conductor having a termination end; a first dielectric layer that overlies the inner conductor; and an outer conductor that overlies the first dielectric layer having a termination end. The right angle coaxial connector comprises: an inner contact comprising a post configured to mate with the inner conductor body of a mating coaxial cable jack, the inner contact further including a receptacle that receives the termination end of the inner conductor such that the post is generally perpendicular to the inner conductor; and an outer conductor body configured to mate with the outer conductor body of the mating coaxial cable jack, the outer conductor body being connected with the termination end of the outer conductor. A second dielectric layer is interposed between the inner contact of the connector and the inner conductor of the coaxial cable, the second dielectric layer creating a capacitive element between the inner contact and the inner conductor.

As a second aspect, embodiments of the invention are directed to a right angle coaxial connector comprising: an inner contact comprising a post configured to mate with the inner conductor body of a mating coaxial cable jack, the inner contact further including a receptacle that is configured to receive the termination end of an inner conductor of a coaxial cable such that the post is generally perpendicular to the inner conductor; and an outer conductor body configured to mate with the outer conductor body of the mating coaxial cable jack, the outer conductor body being connected with the termination end of the outer conductor. A dielectric layer is applied to the receptacle of the inner contact.

As a third aspect, embodiments of the invention are directed to a coaxial cable-connector assembly comprising a coaxial cable and a right angle coaxial connector. The coaxial cable comprises: an inner conductor having a termination end; a first dielectric layer that overlies the inner conductor; and an outer conductor that overlies the first dielectric layer having a termination end. The right angle coaxial connector comprises: an inner contact comprising a post configured to mate with the inner conductor body of a mating coaxial cable jack, the inner contact further including a receptacle that receives the termination end of the inner conductor such that the post is generally perpendicular to the inner conductor; and an outer conductor body configured to mate with the outer conductor body of the mating coaxial cable jack, the outer conductor body being connected with the termination end of the outer conductor. A second dielectric layer is interposed between the inner contact of the connector and the inner conductor of the coaxial cable, the second dielectric layer creating a capacitive element between the inner contact and the inner conductor. The outer conductor body is a monolithic component with a sleeve configured to receive the coaxial cable.

### BRIEF DESCRIPTION OF THE FIGURES

FIG. 1 is a front section view of a right-angle cable-connector assembly according to embodiments of the present invention.

FIG. 2 is an enlarged view of a portion of the assembly of FIG. 1.

FIG. 3 is a front section view of a right-angle cable-connector assembly according to additional embodiments of the present invention.

FIG. 4 is an enlarged view of a portion of the assembly of FIG. 3.

FIG. 5 is a front section view of a right-angle cable-connector assembly according to further embodiments of the present invention.

### DETAILED DESCRIPTION OF EMBODIMENTS OF THE INVENTION

The present invention is described with reference to the accompanying drawings, in which certain embodiments of the invention are shown. This invention may, however, be embodied in many different forms and should not be construed as limited to the embodiments that are pictured and described herein; rather, these embodiments are provided so that this disclosure will be thorough and complete, and will fully convey the scope of the invention to those skilled in the art. It will also be appreciated that the embodiments disclosed herein can be combined in any way and/or combination to provide many additional embodiments.

Unless otherwise defined, all technical and scientific terms that are used in this disclosure have the same meaning as commonly understood by one of ordinary skill in the art to which this invention belongs. The terminology used in the above description is for the purpose of describing particular embodiments only and is not intended to be limiting of the invention. As used in this disclosure, the singular forms “a”, “an” and “the” are intended to include the plural forms as well, unless the context clearly indicates otherwise. It will also be understood that when an element (e.g., a device, circuit, etc.) is referred to as being “connected” or “coupled” to another element, it can be directly connected or coupled to the other element or intervening elements may be present. In contrast, when an element is referred to as being “directly connected” or “directly coupled” to another element, there are no intervening elements present.

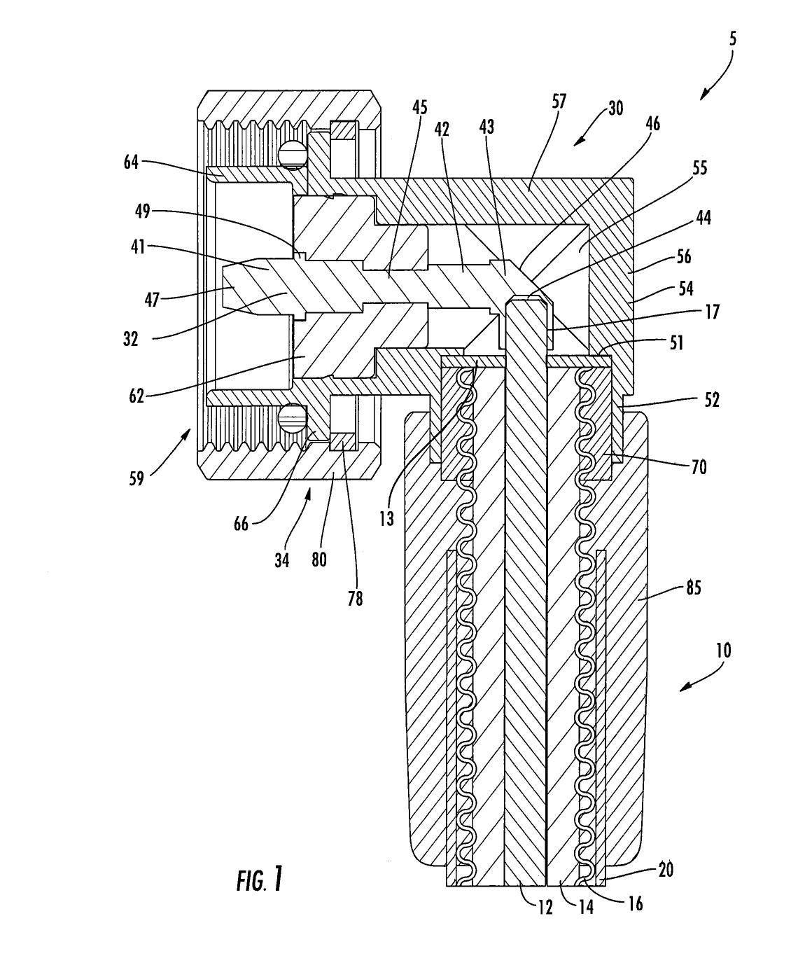

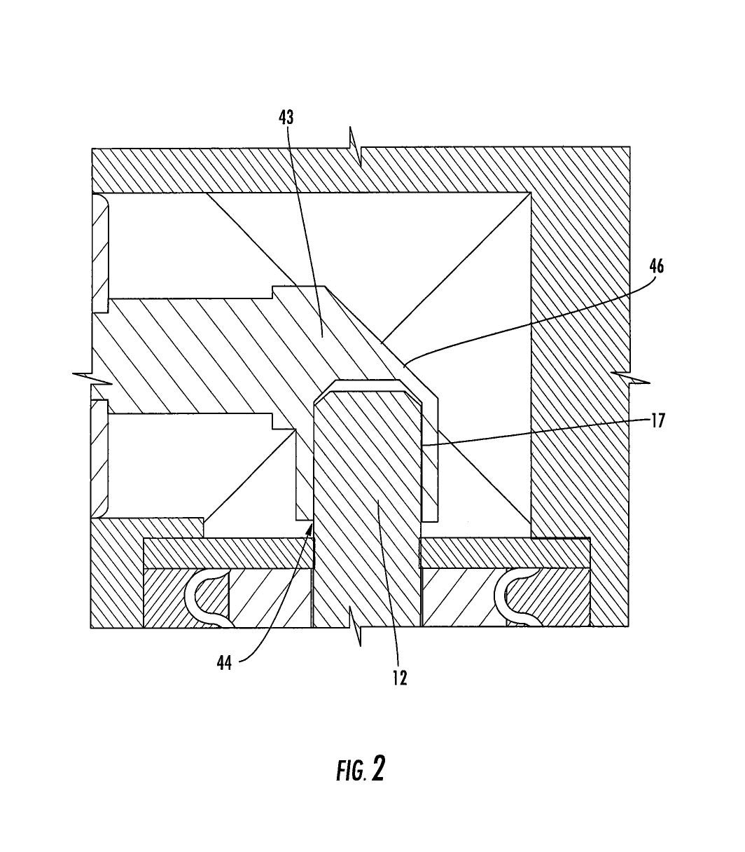

Referring now to the drawings, a right angle connector-cable assembly, designated broadly at 5, is shown in FIGS. 1 and 2. The assembly 5 comprises a coaxial cable 10 and a right angle plug 30, each of which is described in detail below.

Referring to FIG. 1, the coaxial cable 10 includes an inner conductor 12, a dielectric layer 14 that circumferentially overlies the central conductor 12, an outer conductor 16 that circumferentially overlies the dielectric layer 14, and a polymeric cable jacket 20 that circumferentially overlies the outer conductor 16. These components will be well-known to those of skill in this art and need not be described in detail herein. FIG. 1 illustrates that the outer conductor 16 may be of a corrugated profile; alternatively, the outer conductor 16 may have a smooth, braided or foil profile. All of these outer conductor configurations are known to those of skill in this art and need not be described in detail herein. A solder shield 13 is located at the end of the dielectric layer 14 and outer conductor 16.

Referring again to FIG. 1, the plug 30 includes an inner contact 32 and an outer conductor body 34. As can be seen in FIG. 1, the inner contact 32 is generally cylindrical and comprises a post 41 that is configured to mate with the inner conductor body of a mating jack. A ridge 49 extends radially outwardly from the post 41 near the flared tip 47. A finger 42 with a recessed area 45 extends from one end of the post 41; a contact block 43 or other receptacle with a pocket 44 extends from the end of the finger 42. The contact block 43 includes a mitered surface 46.

As shown in FIG. 2, the pocket 44 of the contact block 43 is lined with a dielectric layer 17. The dielectric layer 17 may comprise a coating, a sleeve, or take another thin laminar configuration. The dielectric layer 17 may be formed of various materials with a high dielectric constant, such as polyester, PTFE and other polymeric materials, glass, metal oxides and ceramics.

Referring still to FIG. 1, the outer conductor body 34 includes a cable contact sleeve 52. A housing section 54 rests atop the cable contact sleeve 52, forming a shoulder 51. The housing section 54 includes side walls 55, a rear wall 56, and a ceiling 57. A connector contact section 59 extends away from the housing section 54 opposite the rear wall 56. A dielectric spacer 62 fills an inner portion of the connector contact section 59 and maintains physical and electrical separation of the inner conductor body 32 and the outer conductor body 34. An annular mating ring 64 extends away from the spacer 62 and is configured to mate with a mating jack. A circular flange 66 extends radially outwardly from the connector contact section 59 and provides a bearing surface 82 for interaction with a coupling nut 80 and/or a retaining clip 78.

FIG. 1 illustrates the assembled plug 30 and cable 10. The cable contact sleeve 52 of the outer conductor body 34 fits over the outer conductor 16 of the cable 10, with the termination end of the outer conductor 16 abutting the shoulder 51 of the cable contact sleeve 52 to establish an electrical connection. In illustrated embodiment, a solder joint 70 mechanically and electrically attaches the outer conductor 16 to the cable contact sleeve 52. The inner conductor 12 extends into the cavity of the housing section 54. The pocket 44 of the contact block 43 of the inner conductor body 32 receives the end of the inner conductor 12. The post 41 of the inner conductor body 32 extends through the dielectric spacer 62 and into the space encircled by the mating ring 64. The “right angle” nature of the plug 30 is thus established by the generally perpendicular orientation of the longitudinal axis of the post 41 of the inner conductor body 32 as compared to the longitudinal axis of the inner conductor 12 and the housing section 54. A strain relief sheath 85 covers the lower portion of the cable contact sleeve 52 and adjacent portions of the outer conductor 16 and jacket 20.

Due to the presence of the dielectric layer 17 lining the pocket 44 of the inner contact 32, a capacitive element is created between the inner conductor 12 and the inner contact 32. The capacitive element so created can avoid the generation of PIM that can occur in interconnections between coaxial cables and/or connectors, particularly with soldered connections. Other materials, configurations and techniques for creating capacitive coupling between cable conductors and connectors are discussed in U.S. Patent Publication No. 2014/0370747 to Vaccaro, the disclosure of which is hereby incorporated herein in its entirety.

Also, because the end of the inner conductor 12 can be fitted into the pocket 44 without soldering, there is no need for the connector body 34 to include a port for soldering, thus enabling the connector body 34 to be formed as a single monolithic component (which can also reduce PIM and eliminate the possibility of a cap on the port becoming dislodged or leaking. The inclusion of the mitered surface 46 can provide better electrical performance (some one-piece connector body designs do not permit the inclusion of a mitered surface due to soldering constraints).

It should also be noted that, although the pocket 44 in the contact block 43 is shown as continuous, it may be discontinuous; for example, the contact block 43 may include one or more slots to encourage radial expansion. Receptacles of other configurations may also be suitable for use with the plug 30. In addition, in some embodiments the end of the inner conductor 12 may be covered with the dielectric layer 17 (rather than the pocket 44 being lined with the dielectric layer 17); such a dielectric layer may be a coating, sleeve or the like.

Those of skill in this art will appreciate that, although the plug 30 is illustrated herein, a jack or other connector may be suitable for use with the concepts discussed above. Also, although a galvanic connection is anticipated between the plug 30 and a mating jack, the concepts may be employed with connectors designed for capacitive coupling (see, e.g., U.S. patent application Ser. No. 14/303,745, filed Jun. 13, 2014, the disclosure of which is hereby incorporated herein in its entirety).

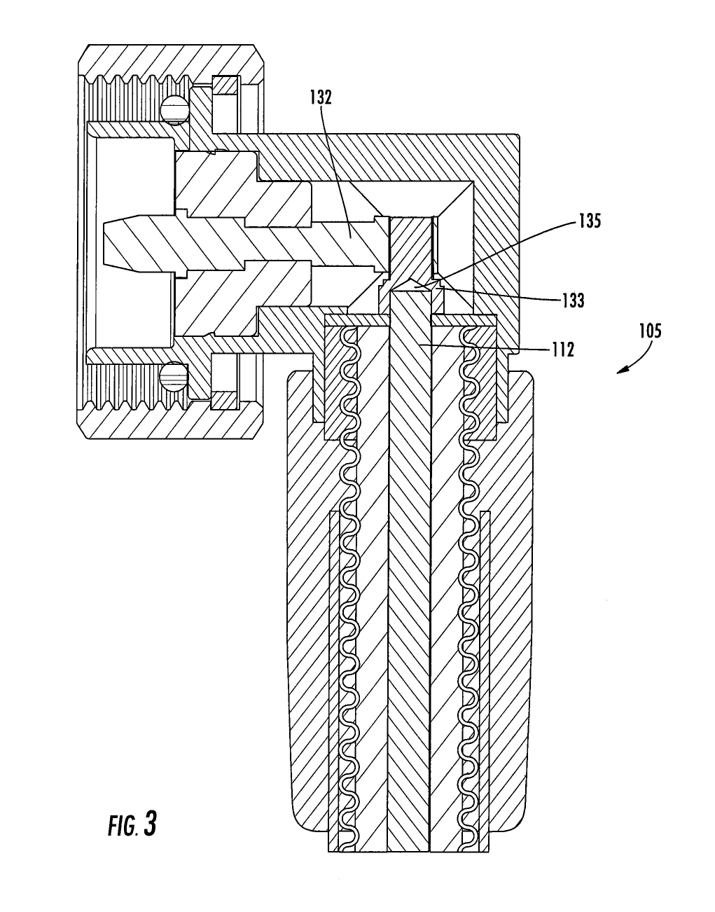

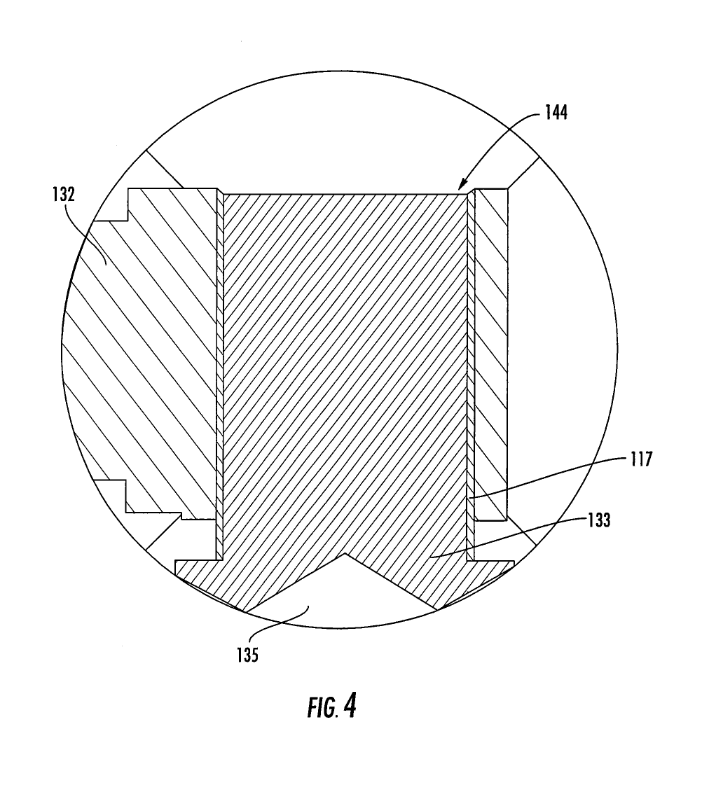

FIGS. 3 and 4 illustrate an alternative embodiment of a cable-connector assembly, designated broadly at 105. The assembly 105 is similar to the assembly 5 described above, with the exception that an inner conductor post 133 is mounted to the end of the inner conductor 112 of the cable 110 and, thus, serves as an extension of the inner conductor 112. The inner conductor post 133 has a recess 135 that receives the end of the inner conductor 112, typically with a soldered joint. At its opposite end, the inner conductor post 133 is inserted into a hole 144 in the inner contact 132. Either of the inner surface of the hole 144 or the outer surface of the inner conductor post 133 includes a dielectric layer 117 that creates a capacitive element between the inner contact 132 and the inner conductor post 133 (see FIG. 4).

This arrangement may have economic and/or practical advantages. Soldering of the secondary inner contact 133 to the end of the inner conductor 112 may be performed prior to insertion into the connector body 134, therefore being more easily controlled. The secondary inner contact 133 may be configured for easier handling than the inner conductor 112. Also, the secondary inner contact 133 may have a surface finish (e.g., for applying the dielectric layer 117) that is preferable to or cannot be achieved by the cable inner conductor 112.

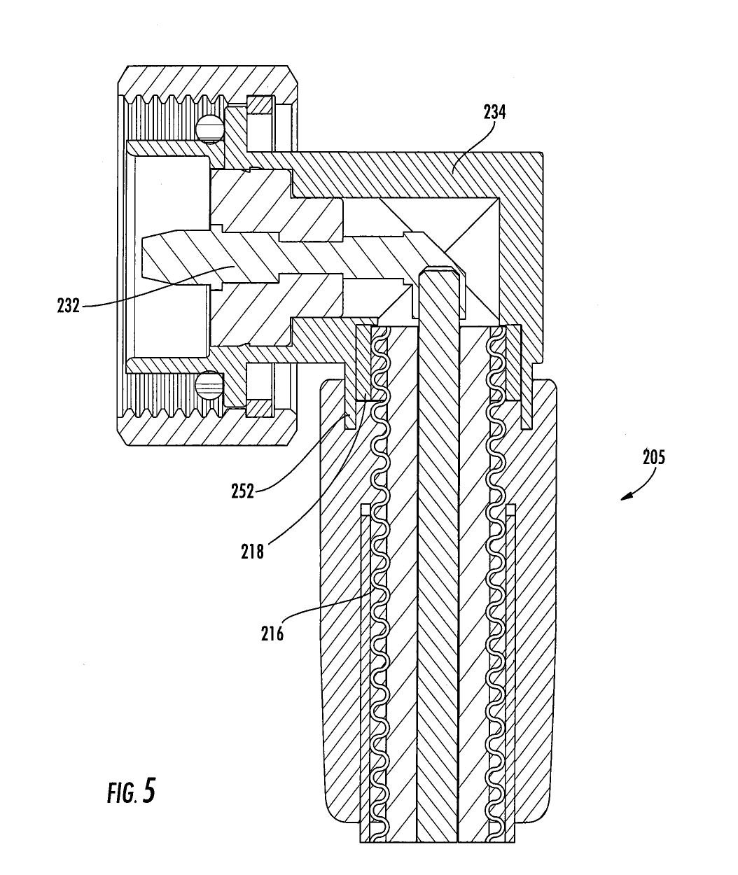

FIG. 5 illustrates an additional embodiment of an assembly 205. In the assembly 205, the connector body 234 is not soldered to the outer conductor 216 of the cable 210; instead, a dielectric layer 218 is interposed between the outer conductor 216 and the sleeve 252 to form a capacitive element therebetween. As such, both of the interfaces between the conductors 212, 216 of the cable 210 and, respectively, the inner contact 232 and the connector body 234 are capacitive, which can reduce PIM. In addition, because no soldering operations are performed, the solder shield shown in assemblies 5, 105 can be omitted.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A coaxial cable-connector assembly, comprising:
(a) a coaxial cable comprising:
an inner conductor having a termination end;
a first dielectric layer that overlies the inner conductor; and
an outer conductor that overlies the first dielectric layer having a termination end; and
(b) a right angle coaxial connector comprising:
an inner contact comprising a post configured to mate with the inner conductor body of a mating coaxial cable jack, the inner contact further including a receptacle that receives the termination end of the inner conductor such that the post is generally perpendicular to the inner conductor;
an outer conductor body configured to mate with the outer conductor body of the mating coaxial cable jack, the outer conductor body being connected with the termination end of the outer conductor;
wherein a second dielectric layer is interposed between the inner contact of the connector and the inner conductor of the coaxial cable, the second dielectric layer creating a capacitive element between the inner contact and the inner conductor.

2. The assembly of claim 1, wherein the outer conductor body is a monolithic component.

3. The assembly of claim 1, wherein the second dielectric layer is applied to the receptacle of the inner contact.

4. The assembly of claim 1, wherein the second dielectric layer is applied to the inner conductor.

5. The assembly of claim 4, wherein the inner conductor includes an inner conductor post at one end, and wherein the second dielectric layer is applied to the inner conductor post.

6. The assembly of claim 1, wherein the inner contact includes a mitered surface adjacent a vertex between the inner conductor and the inner contact.

7. The assembly of claim 1, wherein a second capacitive element is interposed between the outer conductor and the connector body.

8. A right angle coaxial connector comprising:
an inner contact comprising a post configured to mate with the inner conductor body of a mating coaxial cable jack, the inner contact further including a receptacle that is configured to receive the termination end of an inner conductor of a coaxial cable such that the post is generally perpendicular to the inner conductor;
an outer conductor body configured to mate with the outer conductor body of the mating coaxial cable jack, the outer conductor body being connected with the termination end of the outer conductor;
wherein a dielectric layer is applied to the receptacle of the inner contact.

9. The connector of claim 8, wherein the outer conductor body is a monolithic component.

10. The connector of claim 8, wherein the inner contact includes a mitered surface adjacent a vertex between the inner conductor and the inner contact.

11. A coaxial cable-connector assembly, comprising:
(a) a coaxial cable comprising:
an inner conductor having a termination end;
a first dielectric layer that overlies the inner conductor; and
an outer conductor that overlies the first dielectric layer having a termination end; and
(b) a right angle coaxial connector comprising:
an inner contact comprising a post configured to mate with the inner conductor body of a mating coaxial cable jack, the inner contact further including a receptacle that receives the termination end of the inner conductor such that the post is generally perpendicular to the inner conductor;
an outer conductor body configured to mate with the Outer conductor body of the mating coaxial cable jack, the outer conductor body being connected with the termination end of the outer conductor;
wherein a second dielectric layer is interposed between the inner contact of the connector and the inner conductor of the coaxial cable, the second dielectric layer creating a capacitive element between the inner contact and the inner conductor; and
wherein the outer conductor body is a monolithic component with a sleeve configured to receive the coaxial cable.

12. The assembly of claim 11, wherein the second dielectric layer is applied to the receptacle of the inner contact.

13. The assembly of claim 11, wherein the second dielectric layer is applied to the inner conductor.

14. The assembly of claim 13, wherein the inner conductor includes an inner conductor post at one end, and wherein the second dielectric layer is applied to the inner conductor post.

15. The assembly of claim 11, wherein the inner contact includes a mitered surface adjacent a vertex between the inner conductor and the inner contact.

16. The assembly of claim 11, wherein a second capacitive element is interposed between the outer conductor and the connector body.
